(19) United States
(12) Patent Application Publication
(10) Pub. No.: US 2024/0278869 A1
(43) Pub. Date: Aug. 22, 2024

(54) Vehicle With Distinctly Activated Controllers

(71) Applicant: Zhejiang CFMOTO Power Co., Ltd., Hangzhou (CN)

(72) Inventor: Shengfang Wu, Hangzhou (CN)

(21) Appl. No.: 18/581,222

(22) Filed: Feb. 19, 2024

(30) Foreign Application Priority Data
Feb. 22, 2023 (CN) 202310181037.8

(51) Int. Cl. B62J 45/20; B60H 1/00; B60L 53/16; B62J 43/30; B62M 7/00; H01M 10/42; H01M 10/615; H01M 10/625; H01M 10/63; H01M 10/6567; H01M 50/249

(52) U.S. Cl. CPC B62J 45/20; B60H 1/00657; B62J 43/30; B62M 7/00; H01M 10/425; H01M 10/615; H01M 10/625; H01M 10/63; H01M 10/6567; H01M 50/249; B60L 53/16; B60L 2200/12; H01M 2010/4271; H01M 2220/20

(57) ABSTRACT

A vehicle includes a frame, a plurality of wheels supporting the frame, and a prime mover system and battery supported on the frame. The vehicle further includes at least one first controller communicating digitally using a communications protocol on a local area network, and a second controller. The first controller is capable of being activated out of a sleep state by an instruction transmitted by the local area network using the communications protocol, whereas the second controller is capable of being activated out of a sleep state by an activation signal transmitted by directly by hard wires without using the communications protocol.

### RELATED APPLICATION INFORMATION

The present application claims the benefits of priority to Chinese Patent Application No. 202310181037.8, filed with the Chinese Patent Office on Feb. 22, 2023. The entire contents of the above-referenced application is incorporated herein by reference.

### FIELD OF THE DISCLOSURE

The present invention relates to the field of vehicles, and in particular to a motorcycle or an off-road vehicle.

### BACKGROUND OF THE DISCLOSURE

The number of controllers installed on vehicles such as motorcycles and off-road vehicles is increasing to meet more diverse user requirements with the development of vehicle networking and intelligence. However, not every controller needs to be activated simultaneously in different scenarios to save battery power, so as to ensure that the on-board battery maintains charge as long as possible and is always in the normal working state. The controllers in many existing vehicles are mostly activated by network management mechanisms, which requires each controller to have a network signal receiving module and a network signal sending module. This not only increases hardware costs, but also extends the development cycle of each controller and vehicle, thereby resulting in higher development costs.

### SUMMARY OF THE INVENTION

A vehicle is disclosed in the embodiments of the application which reduces the cost of activating hardware in controllers in the vehicle.

The vehicle includes a frame, a plurality of wheels, a prime mover system and an electricity storage bank or battery. The plurality of wheels includes one or a plurality of front wheels and one or a plurality of rear wheels. The prime mover system is arranged on the frame for providing locomotive power to the vehicle, and at least one of the front wheels or the rear wheels is connected to the prime mover system. The electricity storage bank is arranged on the frame for supplying electricity to the vehicle. The vehicle further includes at least a first controller and a second controller. The electricity storage bank is wired to the first controller and the second controller for supplying electricity to the first controller and the second controller. The first controller is connected into a local area network on the vehicle and is capable of being activated by an instruction transmitted using a communications protocol on the local area network. The second controller is capable of being activated by a signal transmitted by direct hard wires to a pin of its microprocessor without using the communications protocol.

For better understanding of other features, objects and advantages of the application, the details of one or more embodiments of the present disclosure are set forth in the drawings and the description below.

### BRIEF DESCRIPTION OF THE DRAWINGS

The drawings described herein are intended to provide a further understanding of the present application and form a part of the present application. The specific embodiments described herein are used to illustrate this application, not to limit the application. In the figures:

FIG. 1 is a side view of a vehicle according to a first preferred embodiment of the present invention;

FIG. 2 is a schematic block diagram illustrating connection of some of the hardware of the vehicle of FIG. 1;

FIG. 3 is a block diagram illustrating remote interaction between the vehicle and a mobile terminal in the first embodiment of the invention;

FIG. 4 is a block diagram illustrating connection of the controllers of the vehicle in more detail; and

FIG. 5 is another block diagram illustrating connection of the controllers of the vehicle in a second embodiment of the invention.

### DETAILED DESCRIPTION

For better understanding of the above objects, features and advantages of the present disclosure, the embodiments of the present disclosure will be described in detail below with reference to the accompanying drawings.

Unless otherwise defined, the technical or scientific terms referred to in the present disclosure shall have the general meaning understood by those with general skills in the technical field to which this disclosure belongs. The terms “comprise (comprising)”, “include (including)”, have (having), and any variants thereof are non-exclusive.

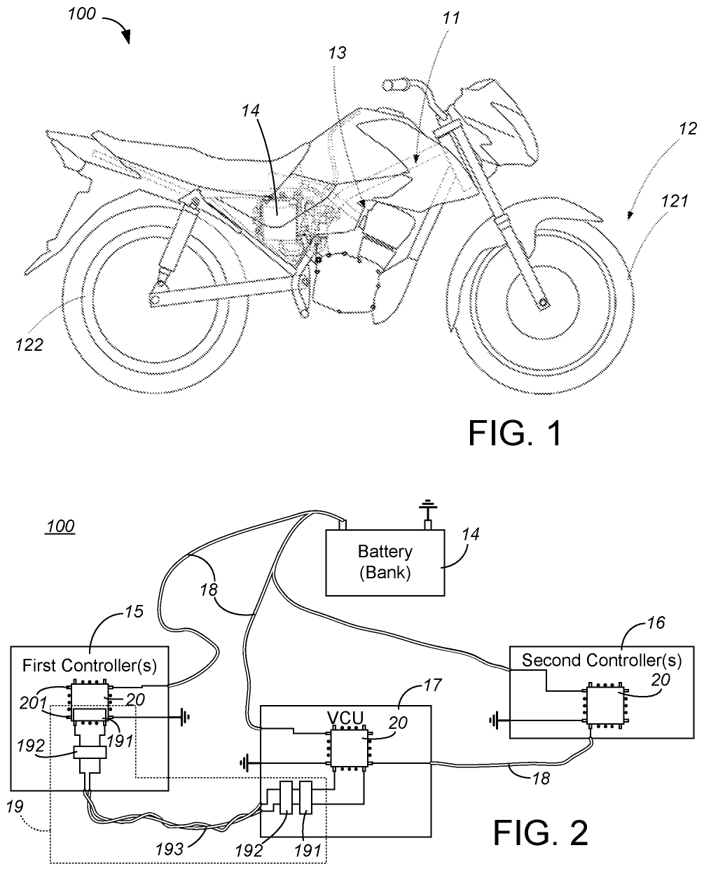

As shown in FIG. 1, a vehicle 100 includes a frame 11, a plurality of wheels 12, a prime mover system 13 and an electricity storage bank 14. The plurality of wheels 12 include at least one front wheel 121 and at least one rear wheel 122. The prime mover system 13 is arranged on the frame 11 for providing locomotive power to the vehicle 100, and at least one of the front wheel 121 or the rear wheel 122 is connected to receive torque from the prime mover system 13. The prime mover system 13 could include either an internal combustion engine or more preferably an electrically-powered motor (either by itself of in addition to the internal combustion engine as a series or parallel hybrid vehicle). The electricity storage bank 14 is arranged so as to be supported by the frame 11 for supplying electricity to the vehicle 100.

It should be noted that the electricity storage bank 14 may be one or more storage batteries, such as lead-acid batteries or lithium batteries. The electricity storage bank 14 at least provides current to the vehicle when the vehicle 100 is started, such as for a starter motor ensuring normal starting of an internal combustion engine of the vehicle 100. In the preferred embodiment, the electricity storage bank 14 can supply electricity to the prime mover system 13, such as a backup power source in a hybrid vehicle. The electricity storage bank 14 can also serve as a large capacitor, effectively protecting the electrical appliances of the vehicle 100.

The present invention may be used in various types of land vehicles, including two-wheeled vehicles, three-wheeled vehicles, and four-wheeled vehicles, with the preferred vehicle 100 being a motorcycle with a single front wheel 121 and a single rear wheel 122. Examples of other two-wheeled vehicles include electrically power assisted bikes such as Enduro Bikes, trail bikes, or the like. Three-wheeled vehicles may have two front wheels and one rear wheel or one front wheel and two rear wheels. Examples of four-wheeled vehicles which can use the present invention include ATVs (All-Terrain Vehicles), UTVs (Utility Terrain Vehicles, multi-purpose vehicles), SSVs (Side by Side Vehicles, tandem vehicles), or the like.

The vehicle 100 includes at least one first controller 15 and at least one second controller 16 as generically shown in FIG. 2 and further includes a vehicle control unit 17. The battery or battery bank 14 is wired to the first controller 15, to the second controller 16, and to the vehicle control unit 17 and is capable of supplying electricity to both controllers 15, 16 and the vehicle control unit 17 via direct wires 18, likely through additional analog power conditioning electrical components (not shown). As well known in the vehicle control arts, each of the first controller 15, the second controller 16 and the vehicle control unit 17 include a microprocessor integrated circuit or “chip” 20 which performs various software/firmware functions and calculations during running of the vehicle 100. While each chip 20 is depicted with eight pins 201 with ellipsis between pins 201, in practice the microprocessor chips used in vehicle controllers can have anywhere from four to sixty-four or more pins or bumps used for electrical connections into or out of the microprocessor chip 20, and the term “pins” as used herein refers to any of these connections 201 to the microprocessor chip 20, regardless of being shaped as a pin, bump, pad or otherwise.

Each of the first controller(s) 15, the second controller(s) 16 and the VCU 17 consume electricity and thus draw at least some current from the battery (bank) 14 even when the vehicle 100 is parked and not running for extended durations. To reduce the current draw and draining of the battery 14, the chips 20 on each of the first and second controller(s) 15, 16 (and possibly VCU 17) have sleep states that they enter either based on an inactivation command or after they have not been actively used for some period of time. For instance, typical land vehicle controllers (including their peripherals) may have a current draw when active that is in a range of about 5 to 150 mA or more, while having a current draw in a sleep state which is less than 5 mA and more typically less than 1 mA. To begin active operation and running of their programming, the chip 20 of each of the first controller(s) 15 and the second controller(s) 16 is activated out of its sleep state by an “activating” signal, and the term “activating signal” as used herein refers to a signal which activates a component out of a sleep state.

The vehicle control unit 17 communicates digitally with the first controller(s) 15 over a local area network 19 using a communication protocol. For instance, many vehicles 100 include a local area network 19 known as a Controller Area Network (CAN). The CAN 19 is capable of exchanging information between various controllers of the vehicle 100 with a data transmission rate of up to 1 Mbit/s (5 Mbit/s on CAN-FD), and each network node can compete to send data to a bus through a bit-by-bit arbitration in a standardized message-based protocol based on the bus access priority, such that the data communication between network nodes has strong and reliable real-time performance using multiplex electrical wiring 193 of the CAN bus. The CAN 19 can carry a large amount of data, which is conducive to intelligent control of vehicles. However, each network node on the CAN bus (including the transmitting node) receives all transmitted frames, and CAN communication requires a CAN controller 191 and a CAN transceiver 192, where the CAN controller 191 is used to receive data from the controller microprocessor 20, to process the data, and to transmit the data to the CAN transceiver 192. The CAN transceiver 192 transmits the data to or from the CAN bus wiring 193 to the CAN controller 191. As shown in FIG. 2, the CAN controller 191 can either be a separate component or part of the controller microprocessor chip 20. Regardless, if a local area network 19 is used to activate the controller(s) 15, 17, a CAN transceiver module 191, 192 needs to be added to the controller 15, 17 which results in higher development costs.

In the present invention, the first controller(s) 15 has access to the local area network 19 and is capable of being activated by an instruction transmitted through the local area network 19. In contrast, the second controller(s) 16 is not on the local area network 19 but instead is capable of being activated by a signal (in some embodiments analog, in some embodiments digital) transmitted by a direct wire 18. The direct wire 18 is electrically connected to one of the pins 201 of the controller chip 20 to directly transmit the activation signal, without the need for additional CAN hardware. If the signal on direct wire 18 is analog, additional analog electrical components (not shown, such as capacitors, resistors, amplifiers, relays etc.) can be added on direct wire 18 to condition the signal and/or otherwise ensure that the direct signal is appropriate for the pin 201 of any given controller chip 20. If the signal on direct wire 18 is digital, additional digital electrical components (not shown, such as filters, etc.) can be added on direct wire 18 to ensure the digital signal is correctly read on the pin 201 of any given controller chip 20. But in no instance is the signal on direct wire 18 subject to a communications protocol or packetized requiring a transceiver to negotiate the communications protocol. Thus, the signal on direct wire 18 is a very different type of signal as compared to the signal on the local area network (CAN bus) wiring 193. The term “direct hard wired” as used herein thus excludes a packetized or communications protocol digital signal. The invention can reduce the hardware cost of controller(s) 16 in vehicles 100 and shorten the development cycle of various controller(s) 16 on the basis of vehicle intelligence, thereby reducing the overall cost of vehicles 100.

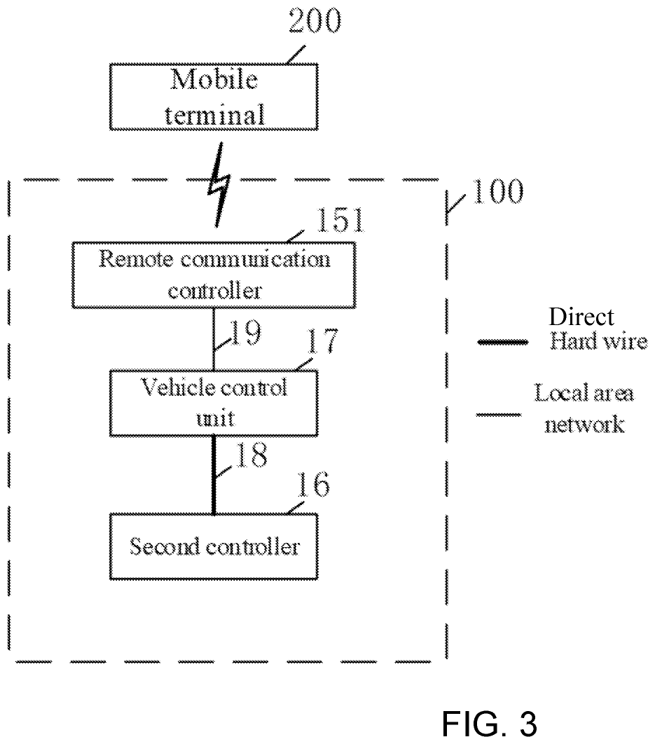

FIG. 3 shows an example of the system of FIG. 2, wherein the first controller is a remote communications controller 151. The remote communication controller 151 is connected to the vehicle control unit 17 by the local area network 19 (the battery power connections, the chips 20 and the transceiver modules 191, 192 shown in FIG. 2 are present in both the remote communication controller 151 and the vehicle control unit 17 but not shown in FIGS. 3-5 to simplify the drawings). The remote communication controller 151 is capable of activating the vehicle control unit 17 via the local area network 19 after receiving a remote command. The activated vehicle control unit 17 is thereafter capable of activating the controller 16 via a hard-wired signal on direct wire 18.

It should be noted that the vehicle control unit 17 is the core controller of the vehicle 100, with functions such as drive control, energy optimization, fault diagnosis and protection, and vehicle status monitoring. The remote communication controller 151 may be a Telematics BOX (also known as a T-BOX) capable of communicating with a mobile terminal 200. For instance, the mobile terminal 200 may be a smartphone, wirelessly communicating with the T-Box 151 such as by Wi-Fi or BLUETOOTH. A user sends instructions via the mobile terminal 200. After receiving the command, the T-BOX 151 activates the vehicle control unit 17 by sending a message on the CAN bus wiring 193. The vehicle control unit 17 executes user instructions to achieve remote control of the vehicle 100, thereby improving convenience.

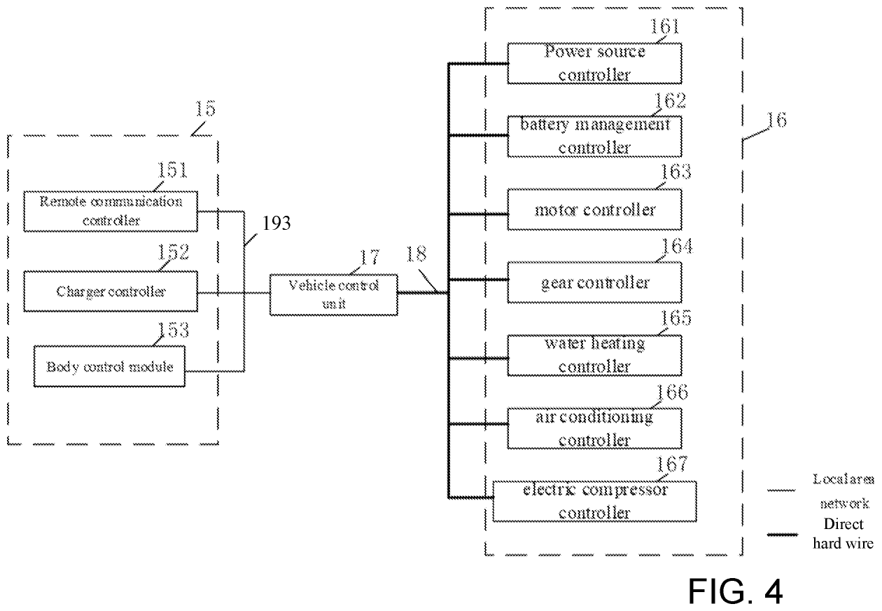

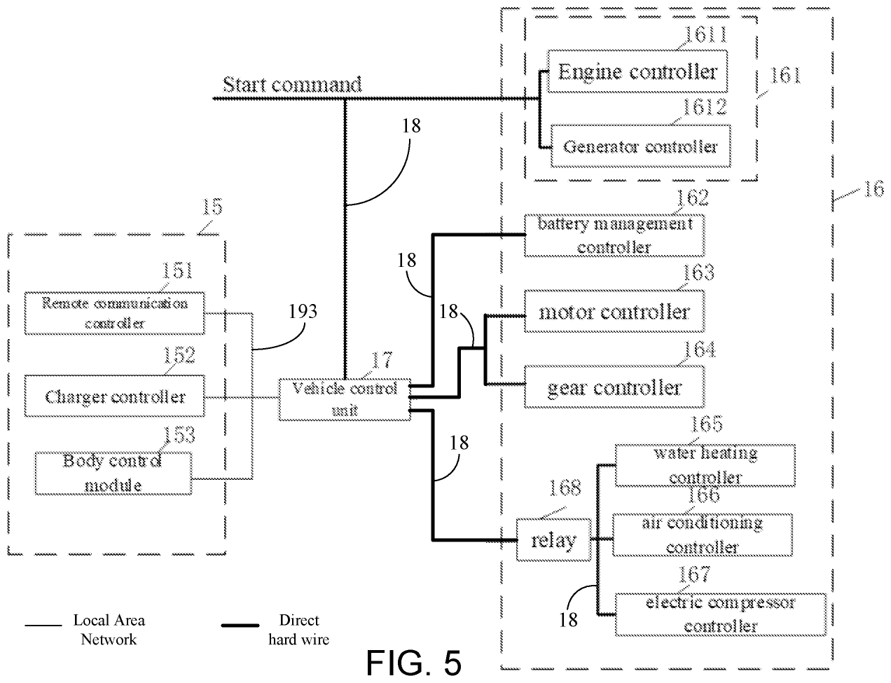

FIG. 4 shows more detailed for a preferred embodiment of the present invention. The prime mover system 13 includes a power source (not separately shown), and one of the second controllers 16 is a power source controller 161. As noted above, in some embodiments, the vehicle 100 is an electric or hybrid vehicle, and the power source for the prime mover system 13 is a power battery (not shown, but on motorcycles commonly located underneath the seat and/or underneath the charging port 131). The vehicle 100 further includes a charging port 131 electrically connected to the power battery. One of the first controllers 15 is a charger controller 152. The charger controller 152 is preferably an On-Board Charger (OBC) controller 152 used to convert AC power input from the power grid into DC power to charge the power battery. The OBC controller 152 can also detect circuit faults during charging and has a protective effect. One of the second controllers 16 is a battery management controller 162 (sometimes referred to as a BMS or Battery Management System controller) capable of monitoring the charging status of the power battery. The charger controller 152 is connected to the vehicle control unit 17 by the local area network 19, while the battery management controller 162 is connected to the vehicle control unit 17 by a direct hard wire 18. When a cover of the charging port 131 is opened and/or a charging gun (not shown, also known as an electric vehicle (“EV”) charging cable or EV charging connector) is plugged into to the charging port 131, the charger controller 152 activates the vehicle control unit 17 via the local area network 19, and then the activated vehicle control unit 17 activates the battery management controller 162 via a direct hard-wired signal. When the OBC 152 charges the power battery, the BMS 162 interacts with the OBC 152 regarding the maximum voltage, the maximum total voltage, the maximum temperature, and the current maximum allowed charging conditions under which the power battery is allowed to charge, so that the power battery can be charged according to the appropriate charging voltage, charging current, and charging method. When the battery level is at a high level, the BMS 162 limits charging, making the charging process switch to a trickle mode until charging is completed, thereby truly saturating the battery cells and extending the service life of the power battery.

In the embodiment of FIG. 4, two further second controllers 16 are a motor controller 163 and a gear controller 164. When the charging gun is received in and connected to the charging port 131, the vehicle control unit 17 activates the motor controller 163 and the gear controller 164 via the direct hard-wired signal. The motor controller 163 preferably controls and monitors the starting and operation, forward and backward speed, and climbing force of the vehicle 100. When the vehicle 100 is ready to charge, the vehicle control unit 17 activates the motor controller 163 via a direct hard-wired signal, and only when the motor controller 163 confirms that the prime mover system 13 is not working and ensures that the vehicle 100 is stationary, is the charging gun allowed to charge the power battery. The gear controller 164 is used to send a gear signal or may be a gear sensor. The vehicle gears include a parking gear, a driving gear, and a neutral gear, etc. When the vehicle 100 is in parking gear, a mechanical device (not shown) locks the power output shaft (not shown) of the vehicle 100 to prevent the vehicle 100 from moving, whereas while when the vehicle 100 is in a neutral gear, the vehicle 100 may still roll. When the vehicle 100 is ready to charge, the vehicle control unit 17 activates the gear controller 164 via a direct hard-wired signal. Only when the gear controller 164 confirms that the vehicle 100 is in the parking gear is the charging gun allowed to charge the power battery, thereby improving safety during battery charging.

In the embodiment shown in FIG. 4, another one of the second controllers 16 is a water heating controller 165. When the charging gun charges the power battery, the vehicle control unit 17 activates the water heating controller 165 via the hard-wired signal on direct hard wire 18. In areas with cold weather, a lower temperature of the power battery can lead to a decrease in battery capacity and performance. If the power battery is a cold lithium battery, lithium may accumulate and cause a short circuit in the power battery, posing a risk of thermal runaway. The water heating controller 165 controls liquid circulation heating to evenly distribute heat into the cold power battery, thereby achieving a uniform increase in the temperature of the power battery. When the charging gun charges the power battery, the vehicle control unit 17 activates the water heating controller 165 to avoid low temperature of the power battery and improves safety during battery charging.

In the embodiment shown in FIG. 4, two further second controllers 16 are an air conditioning controller 166 and an electric compressor controller 167 connected to the vehicle control unit 17 by direct hard wires 18. When the charging gun charges the power battery, the vehicle control unit 17 activates the air conditioning controller 166 and an electric compressor controller 167 via the hard-wired signal on direct hard wire 18. The air conditioning controller 166 and the electric compressor controller 167 can thereafter run during charging of the vehicle 100.

In a preferred version of the embodiment shown in FIG. 4, all of the second controllers 161, 162, 163, 164, 165, 166, 167 are activated simultaneously based on a single activation signal from the vehicle control unit 17 directly on the direct hard wire 18. In a different version of the embodiment shown in FIG. 4, the value of the signal on the direct hard wire 18 can be used to turn on various ones of the second controllers 161, 162, 163, 164, 165, 166, 167 in a predetermined order designed into the system as selected and controlled by the vehicle control unit 17 as well as appropriate reading of the direct hard wired signal by the various chips 20 in the second controllers 161, 162, 163, 164, 165, 166, 167. For instance, the vehicle control unit 17 could a) output an analog signal of 2V on the direct hard wire 18 when the vehicle control unit 17 determines that only the power source controller 161 and the battery management controller 162 should be activated but the motor controller 163, the gear controller 164, the water heating controller 165, the air conditioning controller 166 and the electric compressor controller 167 should be allowed to sleep (such as while power battery charging is continuing during warm weather); b) output an analog signal of 4V on the direct hard wire 18 when the vehicle control unit 17 determines that the power source controller 161, the battery management controller 162, the motor controller 163, and the gear controller 164 should be activated but the water heating controller 165, air conditioning controller 166 and electric compressor controller 167 should be allowed to sleep (such as for several seconds of time when the charging gun is first plugged into the charging port 131 during warm or hot weather); c) output an analog signal of 6V on the direct hard wire 18 when the vehicle control unit 17 determines that the power source controller 161, the battery management controller 162, the motor controller 163, the gear controller 164, and the water heating controller 165 should be activated but the air conditioning controller 166 and electric compressor controller 167 should be allowed to sleep (such as while the charging gun is plugged into the charging port 131 during cold weather); d) output an analog signal of 8V on the direct hard wire 18 when the vehicle control unit 17 determines that all the controllers 161, 162, 163, 164, 165, 166, 167 should be activated (such as whenever the prime mover system 13 is moving the vehicle 100); and e) output an analog signal of 10V on the direct hard wire 18 when the vehicle control unit 17 determines that the power source controller 161, the battery management controller 162, the motor controller 163, the gear controller 164, the air conditioning controller 166 and the electric compressor controller 167 should be activated but and the water heating controller 165 should be allowed to sleep (such as while power battery charging is continuing during hot weather). The specific voltages (or digital signal) used to activate each of the controllers 161, 162, 163, 164, 165, 166, 167 all depend on the design constraints of the various chips 20 selected and the rationale chosen by the vehicle designers, differing from embodiment to embodiment. All of this activation of second controllers 16 occurs without using a communications protocol and without requiring a local area network transceiver in any of the second controllers 16.

In another embodiment represented by FIG. 4, the vehicle control unit 17 activates selected second controllers 16 based on factors other than charging and running of the vehicle 100. For instance, a user can send a command using the mobile terminal 200 to turn on the air conditioning before he/she gets on the vehicle 100. After receiving the user command, the T-BOX 151 activates the vehicle control unit 17 by sending a communications protocol message on the CAN bus wiring 193. The vehicle controller 17 activates the air conditioning controller 166 and electric compressor controller 167. The air-conditioner (not shown) is turned on to adjust the temperature inside or on the vehicle 100 to a comfortable state before the user gets into or on the vehicle 100, thereby enhancing user experience.

As noted above, in the dormant state of the vehicle 100, the static current drain is relatively small, but it still consumes the power of the electricity storage bank 14. After long-term parking, the vehicle 100 may be prone to being unable to start due to insufficient power of the electricity storage bank 14. In the embodiment shown in FIG. 4, one of the first controllers 15 is a body control module 153. Even when the rest of the controllers are in their sleep state, the body control module 153 intermittently monitors the voltage of the electricity storage bank 14. If the voltage of the electricity storage bank 14 descends lower than a preset voltage value, the body control module 153 is capable of activating the vehicle control unit 17 via a communications protocol signal on the local area network 19. As an example, the electricity storage bank 14 is a 12V battery. The body control module 153 is timed to self-activate at selected intervals (perhaps twice daily) and then detect the voltage of the battery. If/when the battery voltage descends below 8.5V, the body control module 153 sends a communications protocol message on the CAN bus wiring 193 to activate the vehicle control unit 17. Once out of its sleep state, the vehicle control unit 17 is capable of controlling the power battery to charge the electricity storage bank 14. This helps to avoid the situation where the vehicle 100 cannot start due to insufficient power in the battery 14 after long-term parking, and can also avoid performance degradation of the battery 14.

In some embodiments, if a charging gun remains connected to the charging port 131, when the remote communication controller 151 receives a charging command from the mobile smartphone 200, then the remote communication controller 151 is capable of activating the charger controller 152 and the vehicle control unit 17 via the local area network 19. The vehicle control unit 17 is capable of activating the battery management controller 162 via a signal on the direct hard wire line 18 to begin charging the power battery via the charging gun. In some embodiments, a battery charging appointment can be stored in the T-BOX 151. The user can set a battery charging appointment by the mobile terminal 200. When the appointment time arrives, the T-BOX 151 activates the charger controller 152 and the vehicle control unit 17 by sending a communications protocol message on the CAN bus wiring 193. In this way, by commanding battery charging remotely or by storing a battery charging appointment, battery charging can be performed during low electricity consumption periods, rather than peak electricity consumption periods in a day, which can save electricity bills for the user and/or otherwise improve convenience of the vehicle 100.

FIG. 5 represents an alternative embodiment which is similar to the embodiments of FIG. 4 but differs in several respects. In the embodiment of FIG. 5, the vehicle 100 is a hybrid vehicle, and the power source controller 161 includes an engine controller 1611 and a generator controller 1612. The vehicle 100 may be started such as by turning a key (not shown), by pressing a start button (not shown) in the vicinity of a key fob (not shown), or by swiping a card (not shown), to generate a start command. The vehicle start command (also known as KL15 or ignition signal) activates the engine controller 1611, the generator controller 1612, and vehicle controller 17 via a direct hard-wired signal on one of the direct hard wires 18. The vehicle control unit 17 then has several output signals on different pins 201 of its chip 20 on different direct hard wires 18. The vehicle control unit 17 a) activates the battery management controller 162, b) activates the motor controller 163 and the gear controller 164; and c) closes the relay 168, at distinct times as needed according to programmed instructions. The relay 168 when closed introduces a battery supply voltage signal (also known as KL30, normal or positive pole of the battery 14) which activates and powers the water heating controller 165, the air conditioning controller 166, and electric compressor controller 167 via a direct hard-wired signal on a different direct hard wire 18. The embodiment of FIG. 5 will be understood by workers skilled in the art to thus demonstrate some of the flexibility of system design achievable by the present invention.

In some embodiments, when the vehicle 100 is powered off, the second controller(s) 16 time out or otherwise are inactivated by the signal on the direct hard wires 18, and the vehicle control unit 17 and the first controller(s) 15 both time out or otherwise are inactivated at the same time via the local area network 19 on the CAN bus wiring 193. This avoids the situation where one or several of the controllers remain active while wrongly expecting other controllers to remain activated.

The details and specifics of the above-mentioned embodiments only exemplify the invention, and should not be construed as a limitation to the scope of protection. It should be noted that for those skilled in the art, without departing from the concept of the present invention, other embodiments, modifications and improvements can be made, which all belong within the scope of the present application. Therefore, the scope of the present application should be determined by the appended claims.

1. A vehicle, being a motorcycle or an off-road vehicle, the vehicle comprising:
a frame;
a plurality of wheels comprising at least one front wheel and at least one rear wheel supporting the frame;
a prime mover system supported by the frame, at least one of the front or rear wheels being rotationally driven by torque from the prime mover system;
at least one first controller supported by the frame and communicating on a CAN bus message protocol network;
at least one second controller supported by the frame, the second controller comprising a microprocessor chip with pins, the second controller having a sleep state and being able to activate out of its sleep state upon receiving an activating signal via a direct hard wired connection to at least one pin of the second controller microprocessor chip, the activating signal not involving a communications protocol; and
a battery supported by the frame supplying electricity to the first and the second controllers.

2. The vehicle of claim 1, further comprising a vehicle control unit, the vehicle control unit being directly hard wired to the second controller, the vehicle control unit also separately communicating on the CAN bus message protocol network.

3. The vehicle of claim 2, wherein the first controller comprises a remote communication controller connected to the vehicle control unit by the CAN bus message protocol network, wherein the remote communication controller is capable of activating the vehicle control unit out of its sleep state via the CAN bus message protocol network after receiving a remote command, and then the activated vehicle control unit is capable of activating the second controller out of its sleep state by initiating the activating signal via the direct hard wired connection.

4. The vehicle of claim 3, wherein the second controller comprises an air conditioning controller and an electric compressor controller, wherein when the remote communication controller receives a command to turn on the air conditioning, the remote communication controller is capable of activating the vehicle control unit out of its sleep state via the CAN bus message protocol network, and then the activated vehicle control unit is capable of activating the air conditioning controller and the electric compressor controller the vehicle control unit via the network after receiving a remote command, and then out of their sleep states by initiating the activating signal via the direct hard wired connection.

5. The vehicle of claim 2, wherein the prime mover system comprises a power source, and the second controller comprises a power source controller, wherein when the vehicle is started, a start command of the vehicle is sent to the power source controller and the vehicle control unit both via a direct hard wired connection to activate both the power source controller and the vehicle control unit out of their sleep states.

6. The vehicle of claim 2, wherein the first controller is a charger controller, and the second controller is a battery management controller capable of monitoring charging status of a power battery, wherein when a charging port of the vehicle is opened to receive a charging gun, the charger controller is capable of activating the vehicle control unit via the CAN bus message protocol network, and then the activated vehicle control unit is capable of activating the battery management controller with an activating signal sent via the direct hard-wired connection.

7. The vehicle of claim 6, wherein the vehicle control unit can be activated out of its sleep state via an activating signal on the CAN bus message protocol network at a charging appointment time stored in the charger controller.

8. The vehicle of claim 6, further comprising a motor controller and a gear controller as second controllers, wherein when charging of the vehicle is started the vehicle control unit is capable of activating the motor controller and gear controller out of their sleep states with an activating signal sent via the direct hard-wired connection.

9. The vehicle of claim 6, further comprising a water heating controller as one of the second controllers, wherein during charging of the vehicle the vehicle control unit is capable of activating the water heating controller out of its sleep state with an activating signal sent via the direct hard-wired connection.

10. The vehicle of claim 2, wherein the vehicle further comprises a power battery for locomotion of the vehicle, and wherein the first controller comprises a body control module which monitors voltage of the battery, and when the voltage of the battery drops lower than a preset voltage value, the body control module is capable of activating the vehicle control unit out of its sleep state via an activating signal on the CAN bus message protocol network, and the vehicle control unit is capable of controlling the power battery to charge the battery.

11. The vehicle of claim 2, wherein when the vehicle is powered off, the second controller is inactivated, and the vehicle control unit and the first controller are both inactivated at the same time via the CAN bus message protocol network.

12. A method of activating a second controller on a vehicle, comprising:
activating a vehicle control unit of a vehicle out of its sleep state via an activating instruction transmitted on a CAN bus message protocol network of the vehicle, the vehicle further comprising:
a frame;
a plurality of wheels comprising at least one front wheel and at least one rear wheel supporting the frame;
a prime mover system supported by the frame, at least one of the front or rear wheels being rotationally driven by torque from the prime mover system;
at least one second controller supported by the frame, the second controller comprising a microprocessor chip with pins, the second controller having a sleep state and being able to activate out of its sleep state upon receiving an activating signal via a direct hard wired connection to at least one pin of the second controller microprocessor chip, the activating signal not involving a communications protocol; and
a battery supported by the frame supplying electricity to the vehicle control unit and the second controller; and
activating the second controller out of its sleep state with the activating signal sent via the direct hard-wired connection.

13. A vehicle, being a motorcycle or an off-road vehicle, the vehicle comprising:
a frame;
a plurality of wheels comprising at least one front wheel and at least one rear wheel supporting the frame;
a prime mover system supported by the frame, at least one of the front or rear wheels being rotationally driven by torque from the prime mover system;
a vehicle control unit supported by the frame and digitally communicating on a local area network using a prioritized messaging protocol, the vehicle control unit having a VCU microprocessor chip with pins;
at least one second controller supported by the frame, the second controller comprising a second controller microprocessor chip with pins, the second controller having a sleep state and being able to activate out of its sleep state upon receiving an activating signal via a direct hard wired connection from at least one pin of the VCU microprocessor chip to at least one pin of the second controller microprocessor chip, the activating signal not involving a communications protocol; and
a battery supported by the frame supplying electricity to the first and the second controllers.
